(19) United States
(12) Patent Application Publication
(10) Pub. No.: US 2024/0351328 A1
(43) Pub. Date: Oct. 24, 2024

(54) LIGHT IRRADIATION MODULE AND PRINTING DEVICE INCLUDING THE SAME

(71) Applicant: Samsung Display Co., Ltd., Yongin-si (KR)

(72) Inventors: JUNGWOOK KIM, Yongin-si (KR); HYUNJIN KIM, Yongin-si (KR); Kyounghee PARK, Yongin-si (KR); JIYUN BANG, Yongin-si (KR); SANGMOO LEE, Yongin-si (KR); TAE-HO LEE, Yongin-si (KR)

(21) Appl. No.: 18/437,010

(22) Filed: Feb. 8, 2024

(30) Foreign Application Priority Data
Apr. 20, 2023 (KR) 10-2023-0052143

(51) Int. Cl. B41F 23/04; B41F 19/00

(52) U.S. Cl. CPC B41F 23/0406; B41F 19/001; B41F 19/007; B41P 2251/10

(57) ABSTRACT

A light irradiation module includes: a stage on which a substrate and a coating layer on the substrate are seated, and which is configured to move in a first direction; a body on the stage; a light-emitting element in a center of the body, and configured to emit light onto the stage; a first suction tube adjacent to the light-emitting element in a second direction crossing the first direction; a duct connected to the first suction tube; and a suction pump connected to the duct, and configured to supply a negative pressure having an absolute value proportional to an intensity of the light to the first suction tube.

### CROSS-REFERENCE TO RELATED APPLICATIONS

The present application claims priority to and the benefit of Korean Patent Application No. 10-2023-0052143, filed on Apr. 20, 2023 in the Korean Intellectual Property Office, the entire disclosure of which is incorporated herein by reference.

### BACKGROUND

### 1. Field

Aspects of some embodiments of the present disclosure herein relate to a light irradiation module and a printing device including the same.

### 2. Description of the Related Art

Electronic apparatuses such as mobile communication terminals, digital cameras, notebook computers, monitors, and televisions include a display device for displaying images.

Display devices generally include a display panel which generates and displays images, and a window panel which is located on the display panel to protect the display panel. The window panel may be attached to an upper portion of the display panel. The images generated by the display panel may be displayed to observers through the window panel.

In addition, the window panel and the display panel may be manufactured in a bonded state so as to minimize or reduce the overall thickness of the display device and to facilitate a set assembly process. As a method for bonding the display panel and the window panel thinly and uniformly, various methods such as bar coating, or slit coating may be used. Here, the overall thickness of the display device may be minimized or reduced by applying a bonding agent thinly and uniformly.

The above information disclosed in this Background section is only for enhancement of understanding of the background and therefore the information discussed in this Background section does not necessarily constitute prior art.

### SUMMARY

Aspects of some embodiments of the present disclosure herein relate to a light irradiation module and a printing device including the same, and for example, to a light irradiation module including a suction tube and a suction pump, and a printing device including the same.

Aspects of some embodiments of the present disclosure include a light irradiation module including a suction pump and a suction tube, and a printing device including the same.

According to some embodiments of the present disclosure, a light irradiation module includes a stage on which a substrate and a coating layer on the substrate are seated, and which moves in a first direction, a body on the stage, a light-emitting element in a center of the body, and emitting light onto the stage, a first suction tube adjacent to the light-emitting element in a second direction crossing the first direction, a duct connected to the first suction tube, and a suction pump connected to the duct, and supplying a negative pressure having an absolute value proportional to an intensity of the light to the first suction tube.

According to some embodiments, the first suction tube may be provided in plurality, and the first suction tubes may include a (1-1)-th suction tube adjacent to one side of the light-emitting element in the second direction, and a (1-2)-th suction tube adjacent to the other side of the light-emitting element in the second direction.

According to some embodiments, the (1-1)-th suction tube and the (1-2)-th suction tube may face each other with the light-emitting element therebetween.

According to some embodiments, the light irradiation module may further include a control unit connected to the light-emitting element and the suction pump, and transmitting an output signal related to the negative pressure and proportional to an input signal to the suction pump, on the basis of the input signal received from the light-emitting element.

According to some embodiments, the control unit may receive a thickness of the coating layer as an initial input value, and change the output signal so that as the initial input value increases, an absolute value of the negative pressure corresponding to the output signal increases.

According to some embodiments, the control unit may receive volatility of the coating layer as an initial input value, and change the output signal so that as the initial input value increases, an absolute value of the negative pressure corresponding to the output signal increases.

According to some embodiments, as the first suction tube gets farther away from the duct, a diameter of the first suction tube may become smaller.

According to some embodiments, the light irradiation module may further include a temperature sensor connected to the control unit, and measuring a temperature of the substrate.

According to some embodiments, the control unit may control the output signal on the basis of the temperature measured by the temperature sensor.

According to some embodiments, the temperature sensor may include a first temperature sensor coupled to an upper surface of the stage, and measuring the temperature of the substrate while being in contact with the substrate, and a second temperature sensor spaced apart from the stage, and measuring temperatures of the substrate and the coating layer while not being in contact with the substrate.

According to some embodiments, the light irradiation module may further include a second suction tube adjacent to the light-emitting element in the first direction, wherein the second suction tube may be provided in plurality, and the second suction tubes may include a (2-1)-th suction tube and a (2-2)-th suction tube face each other along the first direction with the light-emitting element therebetween.

According to some embodiments, a width of the (1-1)-th suction tube along the second direction may be greater than a width of the (2-1)-th suction tube along the first direction.

According to some embodiments, the light irradiation module may further include a heater coupled to at least one of an exterior of the duct or an exterior of the first suction tube.

According to some embodiments, the heater may be provided in plurality, and the heaters may include a first heater coupled to one region of an outer surface of the duct, and providing heat to the duct, and a second heater surrounding an outer surface of the first suction tube, and providing heat to the suction tube.

According to some embodiments, the light irradiation module may further include a moving unit coupled between the duct and the first suction tube, and moving the first suction tube along a shape of the coating layer.

According to some embodiments, the light-emitting element and the suction pump may start operating at the same time.

According to some embodiments of the present disclosure, a printing device includes a stage on which a substrate is seated, and which moves in a first direction, a light irradiation module over the stage, and irradiating the stage with light, and a print head on the stage, located behind the light irradiation module in the first direction, and applying a coating solution onto the substrate to form a coating layer, wherein the light irradiation module includes a body on the stage, a light-emitting element in a center of the body, and emitting light onto the stage, a suction tube adjacent to the light-emitting element in a second direction crossing the first direction, a duct connected to the suction tube, and a suction pump connected to the duct, and supplying a negative pressure having an absolute value proportional to an intensity of the light to the suction tube.

According to some embodiments, a distance by which the print head is spaced apart from the light irradiation module along the first direction may be about 200 mm or less.

According to some embodiments, the suction tube may be provided in plurality, and the suction tubes may include a first suction tube adjacent to one side of the light-emitting element in the second direction, and a second suction tube adjacent to the other side of the light-emitting element in the second direction.

According to some embodiments, as a thickness of the coating layer increases, the absolute value of the negative pressure provided by the suction pump may increase.

### BRIEF DESCRIPTION OF THE DRAWINGS

The accompanying drawings are included to provide a further understanding of the present disclosure, and are incorporated in and constitute a part of this specification. The drawings illustrate aspects of some embodiments of the present disclosure and, together with the description, serve to explain aspects of some embodiments of the present disclosure. In the drawings:

FIG. 1 is a perspective view of a printing device according to some embodiments of the present disclosure;

FIG. 2 is a bottom view of a light irradiation module and a print head according to some embodiments of the present disclosure;

FIG. 3 is a side view of a light irradiation module according to some embodiments of the present disclosure;

FIGS. 4A and 4B are photographs showing a coating layer and a hole according to some embodiments of the present disclosure;

FIG. 5 is a side view of a light irradiation module according to some embodiments of the present disclosure;

FIG. 6 is a perspective view of a printing according to some embodiments of the present disclosure;

FIG. 7 is a bottom view of a light irradiation module and a print head according to some embodiments of the present disclosure;

FIG. 8 is a perspective view of a printing device according to some embodiments of the present disclosure;

FIG. 9 is a side view of a light irradiation module according to some embodiments of the present disclosure;

FIGS. 10A to 10C are front views illustrating operations of a printing device according to some embodiments of the present disclosure; and

FIG. 11 is an exploded perspective view schematically illustrating aspects of a display device according to some embodiments of the present disclosure.

### DETAILED DESCRIPTION

In this specification, when a component (or region, layer, portion, etc.) is referred to as “on”, “connected”, or “coupled” to another component, it means that it is placed/connected/coupled directly on the other component or a third component can be located between them.

The same reference numerals or symbols refer to the same elements. In addition, in the drawings, thicknesses, ratios, and dimensions of components are exaggerated for effective description of technical content. “And/or” includes all combinations of one or more that the associated elements may define.

Terms such as first and second may be used to describe various components, but the components should not be limited by the terms. These terms are only used for the purpose of distinguishing one component from other components. For example, without departing from the scope of the present invention, a first component may be referred to as a second component, and similarly, a second component may be referred to as a first component. Singular expressions include plural expressions unless the context clearly indicates otherwise.

In addition, terms such as “below”, “lower”, “above”, and “upper” are used to describe the relationship between components shown in the drawings. The terms are relative concepts and are described based on the directions indicated in the drawings.

Terms such as “include” or “have” are intended to designate the presence of a feature, number, step, action, component, part, or combination thereof described in the specification, and it should be understood that it does not preclude the possibility of presence or addition of one or more other features, numbers, steps, operations, components, parts, or combinations thereof.

Unless otherwise defined, all terms (including technical and scientific terms) used in this specification have the same meaning as commonly understood by one of ordinary skill in the art to which this invention belongs. In addition, terms such as terms defined in commonly used dictionaries should be interpreted as having a meaning consistent with the meaning having in the context of the related technology, and should not be interpreted as too ideal or too formal unless explicitly defined here.

Hereinafter, aspects of some embodiments of the present disclosure will be described in more detail with reference to the accompanying drawings.

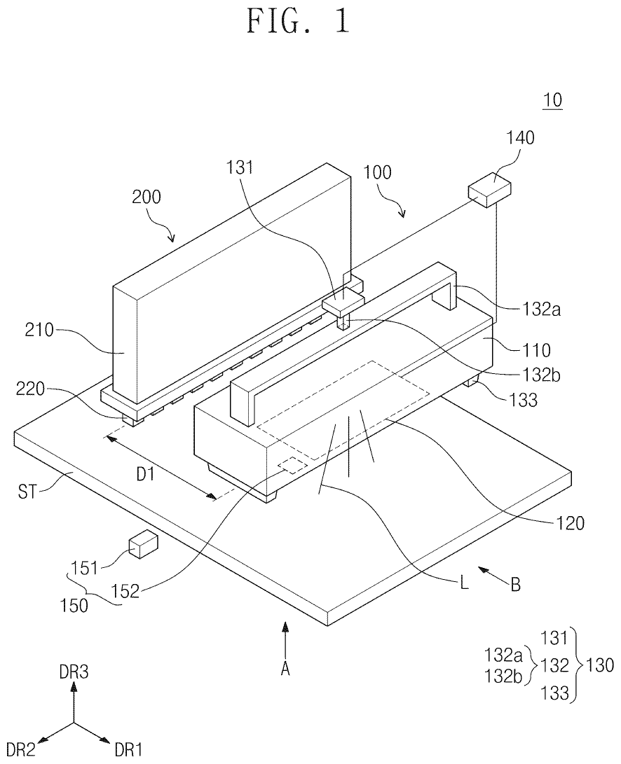

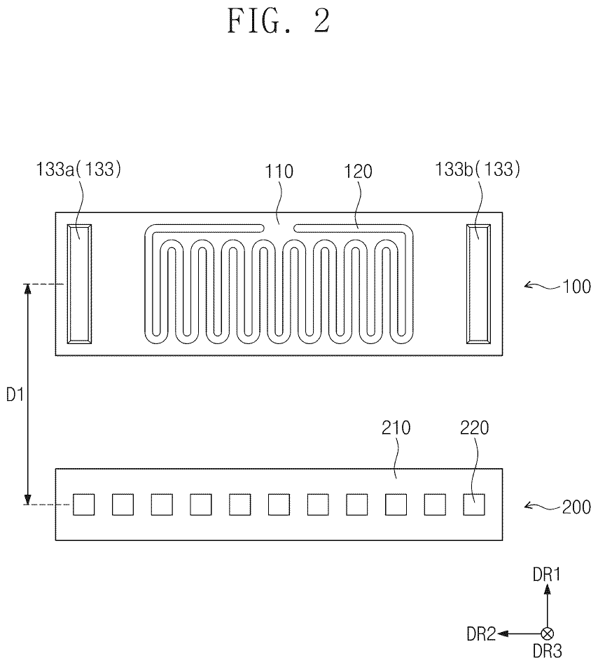

FIG. 1 is a perspective view of a printing device 10 according to some embodiments of the present disclosure. FIG. 2 is a bottom view of a light irradiation module 100 and a print head 200 according to some embodiments of the present disclosure. FIG. 2 is the bottom view of the light irradiation module 100 and the print head 200 as seen in the direction A in FIG. 1.

Referring to FIGS. 1 and 2, the printing device 10 may include the light irradiation module 100 and the print head 200. The printing device 10 may successively perform an operation of applying a coating solution onto a substrate which is a working target, and an operation of curing the applied coating solution. The printing device 10 may reduce a required process time by curing immediately (or subsequently) after applying the coating solution.

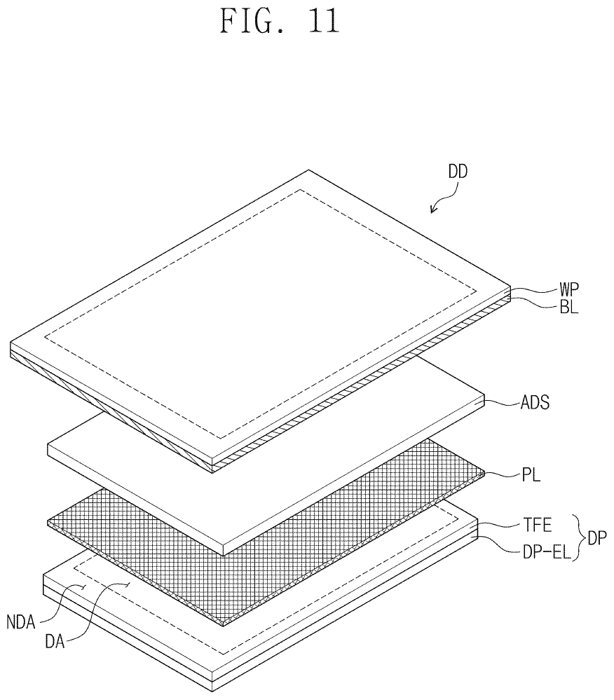

The printing device 10 may be used to manufacture components, requiring processes of applying and curing the coating solution, like an adhesive layer ADS (see FIG. 11) and a light-blocking layer BL (see FIG. 11) of a display device DD in FIG. 11. For example, when an optically clear resin (OCR) is used as the coating solution, the adhesive layer ADS (see FIG. 11) in FIG. 11 may be formed. For example, when a light-blocking material is used as the coating solution, the light-blocking layer BL (see FIG. 11) in FIG. 11 may be formed. However, components which may be manufactured with the printing device 10, are not limited thereto, and any component, which will undergo applying and curing of the coating solution may be manufactured.

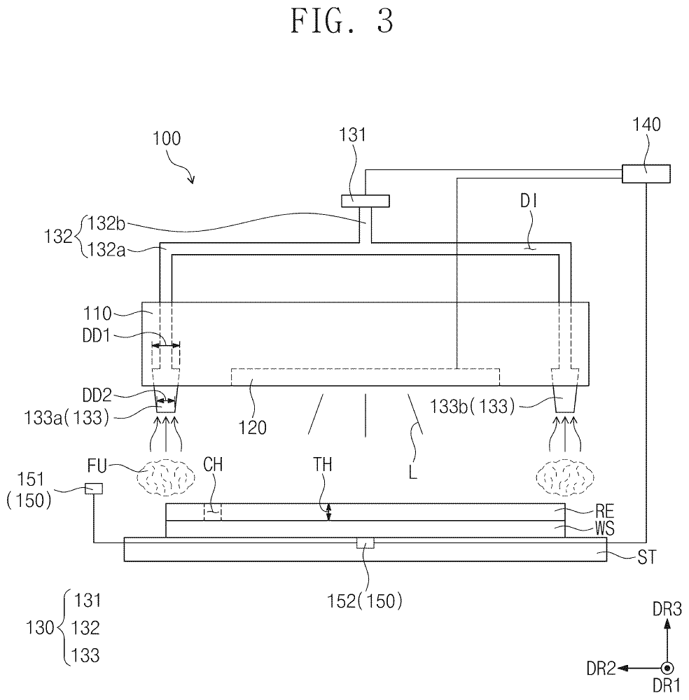

The light irradiation module 100 may include a stage ST, a body 110, a light-emitting element 120, an exhaust unit 130, a control unit 140, and a temperature sensor 150. The light irradiation module 100 may emit light L onto a substrate WS (see FIG. 3) in FIG. 3 to cure a coating layer RE (see FIG. 3). The light irradiation module 100 may be located in front of a print head 200 in a first direction DR1. The light irradiation module 100 may be spaced apart from an upper surface of the stage ST by a distance (e.g., a set or predetermined distance) along a third direction DR3. A person with ordinary skill in the art related to these embodiments may understand that a configuration of the light irradiation module 100 is not limited thereto, and general-purpose components may be further included in the light irradiation module 100.

The stage ST may be a flat panel on which the substrate WS (see FIG. 3) and the coating layer RE (see FIG. 3) located on the substrate WS (see FIG. 3) are seated. A planar shape and a planar size of the stage ST may not be limited. However, FIG. 1 illustrates, as an example, that the stage ST is a quadrilateral on a plane. The stage ST may provide a space in which the substrate WS (see FIG. 3) is seated.

The stage ST may move in the first direction DR1. Because the stage ST moves in the first direction DR1, the substrate WS (see FIG. 3) located on the stage ST may overlap the print head 200 and then overlap the light irradiation module 100. When the substrate WS (see FIG. 3) located on the stage ST overlaps the print head 200, the process of applying the coating solution may be performed. When the substrate WS (see FIG. 3) located on the stage ST overlaps the light irradiation module 100, the process of curing the coating solution may be performed. That is, while the stage ST moves in the first direction DR1, the processes of applying the coating solution onto the substrate WS (see FIG. 3), and curing the coating solution may be successively (or sequentially) performed.

A planar area occupied by the stage ST may be greater than a planar area occupied by the substrate WS (see FIG. 3). The stage ST may include a material having durability and thermal resistance not to be damaged by the light L emitted by the light-emitting element 120, and having low reactivity not to react even at a high temperature.

The body 110 may be located on the stage ST. The light-emitting element 120 may be located in or at the center of the body 110 and emit the light L onto the stage ST. The light-emitting element 120 may be a lamp for emitting the light L. However, the light-emitting element 120 may be used not only as the light-emitting element 120 itself for emitting the light L, but also as a unit for emitting light. The light-emitting element 120 may be provided in plurality as needed. The light-emitting element 120 may include a plurality of light sources spaced apart from each other in a second direction DR2 crossing the first direction DR1.

The light L emitted by the light-emitting element 120 may be ultraviolet rays for curing the coating layer RE (see FIG. 3). The light L emitted by the light-emitting element 120 may be ultraviolet rays having a wavelength of about 10 nm to about 400 nm. The light L may be ultraviolet rays having an intensity of about 150 mW/cm² to about 2000 mW/cm².

The exhaust unit 130 may be located on the stage ST and suction ambient air. The exhaust unit 130 may suction foreign matters and gas FU (see FIG. 3) formed by the light L emitted by the light-emitting element 120. The exhaust unit 130 may provide a negative pressure having an absolute value proportional to the intensity of the light L. The exhaust unit 130 may be a vacuum regulator or a pressure regulator in which the negative pressure is changed according to the intensity of the light L. However, a type of the exhaust unit 130 is not limited to what is described above, and any device capable of providing a negative pressure having an absolute value proportional to the intensity of the light L may be provided as the exhaust unit 130.

The exhaust unit 130 may include a suction pump 131, a duct 132, and a suction tube 133. However, a configuration of the exhaust unit 130 is not limited thereto, and may also include another general-purpose component. The suction pump 131 may be connected to the duct 132 to provide, to the suction tube 133, the negative pressure having the absolute value proportional to the intensity of the light L. The suction pump 131 and the light-emitting element 120 may start operating at the same time. The suction pump 131 may be connected to the control unit 140 to determine the negative pressure on the basis of an output signal received from the control unit 140.

The duct 132 may be connected to the suction tube 133 and serve as a passage for air, foreign matters, and gas FU (see FIG. 3) suctioned by the suction tube 133. The duct 132 may connect the suction pump 131 and the suction tube 133. The duct 132 may transfer, to the suction tube 133, the negative pressure supplied by the suction pump 131. The duct 132 may have a shape of a hollow pipe. The duct 132 may include a suction duct 132a and a connection duct 132b.

The suction duct 132a may be a pipe directly connected to the suction tube 133. When the suction tube 133 is provided in plurality, the suction duct 132a may be connected to each of the plurality of suction tubes 133. The suction duct 132a may have a plurality of branched end portions to be respectively connected to the plurality of suction tubes 133. For example, referring to FIG. 3 together, the suction duct 132a may be branched into two paths so that one end may be connected to a (1-1)-th suction tube 133a and the other end may be connected to a (1-2)-th suction tube 133b.

The connection duct 132b may be connected between the suction pump 131 and the suction duct 132a. An exhaust pressure of the suction pump 131 may be transferred to the suction tube 133 by the suction duct 132a and the connection duct 132b.

The suction tube 133 may be located adjacent to the light-emitting element 120 in the second direction DR2 crossing the first direction DR1. The suction tube 133 may be connected to the body 110, and be located adjacent to a side surface of the light-emitting element 120 along the second direction DR2. The suction tube 133 may protrude from the body 110 toward the stage ST. The suction tube 133 may be located adjacent to both side surfaces of the body 110. The suction tube 133 may be connected to the suction pump 131 by the duct 132. The suction tube 133 may collect foreign matters and gas FU (see FIG. 3) in a working space by using the negative pressure transferred by the suction pump 131.

The suction tube 133 may include the (1-1)-th suction tube 133a and the (1-2)-th suction tube 133b. The (1-1)-th suction tube 133a may be located adjacent to one side of the light-emitting element 120 in the second direction DR2. The (1-2)-th suction tube 133b may be located adjacent to the other side of the light-emitting element 120 in the second direction DR2. The light-emitting element 120 may be located between the (1-1)-th suction tube 133a and the (1-2)-th suction tube 133b. The (1-1)-th suction tube 133a and the (1-2)-th suction tube 133b may face each other in the second direction DR2 with the light-emitting element 120 therebetween. The (1-1)-th suction tube 133a and the (1-2)-th suction tube 133b may be respectively connected to end portions of the suction duct 132a.

The (1-1)-th suction tube 133a may be located more adjacent to one side surface of the body 110 than the light-emitting element 120 in the second direction DR2. The (1-2)-th suction tube 133b may be located more adjacent to the other side surface of the body 110 than the light-emitting element 120 in the second direction DR2. Accordingly, the light L emitted by the light-emitting element 120 may be blocked by the (1-1)-th suction tube 133a and the (1-2)-th suction tube 133b to a minimum.

The control unit 140 may be connected to the light-emitting element 120 and the suction pump 131, and may transmit an output signal to the suction pump 131 on the basis of an input signal received from the light-emitting element 120. The input signal of the control unit 140 may be a signal related to the intensity of the light L emitted by the light-emitting element 120. The output signal generated by the control unit 140 may be a signal related to the negative pressure supplied by the suction pump 131. The output signal of the control unit 140 may be proportional to the input signal.

That is, as the intensity of the light L emitted by the light-emitting element 120 becomes greater, the negative pressure supplied by the suction pump 131 operating according to the output signal may become greater. Accordingly, the absolute value of the negative pressure supplied by the suction pump 131 may be proportional to the intensity of the light L emitted by the light-emitting element 120. The suction pump 131 may operate in response to the output signal generated by the control unit 140.

The temperature sensor 150 may be connected to the control unit 140, and measure a temperature of the substrate WS. The temperature sensor 150 may transfer the temperatures of the substrate WS and the coating layer RE (see FIG. 3) to the control unit 140 in real-time. The control unit 140 may control the output signal based on temperature data received from the temperature sensor 150.

The temperature sensor 150 may include a first temperature sensor 151 and a second temperature sensor 152. The first temperature sensor 151 may be coupled to an upper surface of the stage ST, and may be in contact with the substrate WS to measure the temperature of the substrate WS. The first temperature sensor 151 may be a contact-type temperature sensor. For example, a thermocouple temperature sensor, a thermistor temperature sensor, a resistance temperature detector (RTD), or the like may be used as the first temperature sensor 151. However, a type of the first temperature sensor 151 is not limited thereto, and various contact-type temperature sensors may be used as the first temperature sensor 151.

The second temperature sensor 152 may be spaced apart from the stage ST, and measure the temperatures of the substrate WS and the coating layer RE (see FIG. 3) while not being in contact with the substrate WS. The second temperature sensor 152 may be a non-contact-type temperature sensor. For example, the second temperature sensor 152 may be an infrared temperature sensor. However, a type of the second temperature sensor 152 is not limited thereto, and various non-contact-type temperature sensors may be used as the second temperature sensor 152. Accordingly, the accuracy of temperature data measured in real-time may be improved by using contact-type temperature sensors and non-contact-type temperature sensors as the temperature sensor 150.

The print head 200 may be located over the stage ST and apply a coating solution onto the substrate WS to form the coating layer RE (see FIG. 3). The print head 200 may be located behind the light irradiation module 100 in the first direction DR1, which is a moving direction of the stage ST. When the stage ST moves along the first direction DR1, the stage ST or the substrate WS (see FIG. 3) may overlap the print head 200 and then overlap the light irradiation module 100.

The print head 200 may be spaced apart from the light irradiation module 100 by a distance (e.g., a set or predetermined distance) D1 along the first direction DR1. The distance D1 by which the print head 200 and the light irradiation module 100 are spaced apart from each other may be about 200 mm or less. When the distance D1 by which the light irradiation module 100 and the print head 200 are spaced apart from each other is greater than about 200 mm, the time taken from the process of applying the coating solution by the print head 200 to the process of curing the coating solution by the light irradiation module 100 may increase. Accordingly, the total process time required for applying and curing the coating solution may become longer. When the process time becomes longer, the coating layer RE (see FIG. 3) may not have a desired shape, or foreign matters may be introduced. For example, because it takes long time to cure the applied coating solution, the coating solution applied to the outer surface may move to a central portion due to a surface tension.

The print head 200 may include a print body 210 and a nozzle 220. The print body 210 may be located over the stage ST. The print body 210 may include an internal space in which the coating solution to be applied onto the substrate WS (see FIG. 3) is placed. The nozzle 220 may be exposed at a lower portion of the print body 210. The nozzle 220 may spray, onto the substrate WS (see FIG. 3), the coating solution present inside the print body 210. The nozzle 220 may be provided in plurality. The plurality of nozzles 220 may be arranged in a form of at least one row along an axis extending in the second direction DR2.

FIG. 3 is a side view of a light irradiation module 100 according to some embodiments of the present disclosure. FIG. 3 is a side view of the light irradiation module 100 seen in direction B in FIG. 1.

Referring to FIG. 3, the exhaust unit 130 may suction and remove the gas FU formed by the light L emitted by the light irradiation module 100. Here, the coating solution applied by the print head 200 may be cured by the light irradiation module 100 to form the coating layer RE. The coating solution may be vaporized during curing of the coating layer RE to form the gas FU.

The gas FU may be liquefied in the nozzle 220 (see FIG. 1) after the curing process, and may thus contaminate the nozzle 220 (see FIG. 1) of the print head 200 (see FIG. 1). The gas FU may be liquefied in the light-emitting element 120 after the curing process and may thus deteriorate uniformity of the light L emitted by the light-emitting element 120. The gas FU may be liquefied on the coating layer RE or the substrate WS after the curing process and may thus deteriorate product quality or cause reliability failure.

For example, when a hole CH is formed in the coating layer RE to improve transmittance of a sensor, the gas FU may be liquefied inside the hole CH to become foreign matters. In this case, the transmittance of the sensor may decrease to deteriorate the product quality. Accordingly, the above problem may be solved by removing the gas FU by the exhaust unit 130.

A generation amount of the gas FU may be proportional to the intensity of the light L emitted by the light-emitting element 120. That is, when the intensity of the light L emitted by the light-emitting element 120 increases, an amount of heat generated by the coating layer RE may increase, and therefore the generation amount of the vaporized gas FU may increase. Accordingly, an exhaust pressure of the exhaust unit 130 should be increased in proportion to the intensity of the light L emitted by the light-emitting element 120.

The suction pump 131 may be connected to the suction tube 133 via the duct 132 in which an internal space DI is formed. The suction tube 133 may suction the gas FU with the negative pressure supplied by the suction pump 131. The gas FU suctioned by the suction tube 133 may move through the internal space DI of the duct 132 to be discharged to the outside.

As the suction tube 133 gets father away from the duct 132, a diameter of the suction tube 133 may become smaller. A diameter DD1 of one end, of the suction tube 133, adjacent to the duct 132 may be greater than a diameter DD2 of the other end, of the suction tube 133, far from the duct 132. Accordingly, a path of the light L emitted by the light-emitting element 120 may be prevented from being obstructed by the suction tube 133.

The control unit 140 may receive a thickness TH of the coating layer RE as an initial input value. When the thickness TH of the coating layer RE, which is the initial input value, increases, the control unit 140 may change an output signal so as to increase the absolute value of the negative pressure corresponding to the output signal. That is, when the thickness TH of the coating layer RE increases, the negative pressure supplied to the suction tube 133 by the suction pump 131 may increase. This is because when the thickness TH of the coating layer RE increases, the amount of the vaporized coating solution with respect to the same intensity of the light L increases to result in an increase in the gas FU.

The control unit 140 may receive volatility of the coating layer RE as an initial input value. Here, the volatility may be proportional to an amount of gas vaporized at the same temperature. When the volatility, which is the initial input value, increases, the control unit 140 may change the output signal to increase the negative pressure corresponding to the output signal. That is, when a highly volatile material such as a monomer having a small molecular weight is used as the coating layer RE, the negative pressure supplied to the suction tube 133 by the suction pump 131 may be increased. In this way, the control unit 140 may change the output signal according to the initial input value to control the absolute value of the negative pressure of the suction pump 131. Accordingly, the exhaust unit 130 may be actively controlled according to the generation amount of the gas FU.

The control unit 140 may change the output signal on the basis of temperature data received from the temperature sensor 150. The first temperature sensor 151 and the second temperature sensor 152 may measure the temperatures of the substrate WS and the coating layer RE in real-time. When the temperature of the coating layer RE increases, the generation amount of the gas FU may increase. When the temperature of the substrate WS and the temperature of the coating layer RE respectively measured in the first and second temperature sensors 151 and 152 increase, the output signal may be changed so as to increase the absolute value of the negative pressure corresponding to the output signal.

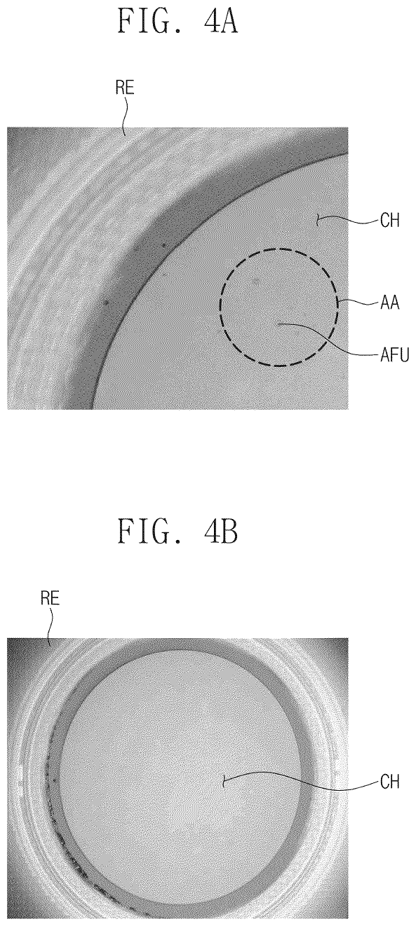

FIGS. 4A and 4B are photographs showing the coating layer RE and the hole CH according to some embodiments of the present disclosure. More specifically, FIG. 4A is a photograph showing a plane of the coating layer RE and the hole CH in a case in which the exhaust unit 130 is not applied, and FIG. 4B is a photograph showing a plane of the coating layer RE and the hole CH in a case in which the exhaust unit 130 is applied. The intensity of the light L emitted by the light-emitting element 120 in both of FIGS. 4A and 4B is about 1000 mW/cm².

Referring to FIG. 4A, it may be confirmed that there are foreign matters AFU formed by liquefying the gas FU. When seeing region AA inside the hole CH, it may be confirmed that there are multiple foreign matters AFU. However, referring to FIG. 4B, it may be confirmed that the foreign matters AFU are not formed over the entire area of the hole CH. It may be seen that the exhaust unit 130 prevents the foreign matters AFU from being formed by removing the gas FU before being liquefied.

Table 1 below shows numbers of the foreign matters AFU inside the hole CH according to use of the printing device 10 in FIGS. 1 to 4B. Table 1 also shows numbers of the foreign matters AFU inside the hole CH according to the intensity of the light L emitted by the light-emitting element 120 and the negative pressure supplied by the suction pump 131. Here, the numbers of the foreign matters AFU represent the numbers of the foreign matters AFU viewed inside the hole CH. The foreign matters AFU were viewed using a microscope, and only numbers are counted and showed irrespective of sizes of the foreign matters AFU.

TABLE 1

| | Intensity | Negative | Number |
|---|---|---|---|
| | of light L | pressure | of foreign |
| Example | (mW/cm²) | (kPa) | matters AFU |
| Example 1 | 2000 | −60 | 0 |
| Example 2 | 2000 | −30 | 21 |
| Example 3 | 1000 | −30 | 0 |
| Example 4 | 1000 | −15 | 9 |
| Example 5 | 500 | −15 | 0 |
| Example 6 | 300 | −9 | 0 |
| Comparative | 150 | 0 | 0 |
| Example 1 | | | |

Referring to Table 1, when the intensity of the light L was 150 mW/cm² as in Comparative Example 1, the foreign matters AFU were not viewed inside the hole CH although the negative pressure of the suction pump 131 was 0 kPa. In Example 6, when the intensity of the light L was 300 mW/cm², and the negative pressure of the suction pump 131 was-9 kPa, the foreign matters AFU were not viewed inside the hole CH. In Example 5, when the intensity of the light L was 500 mW/cm², and the negative pressure of the suction pump 131 was-15 kPa, the foreign matters AFU were not viewed inside the hole CH. Referring to Examples 4 and 5, the negative pressures supplied by the suction pump 131 were the same as −15 kPa, and only the intensities of the light L were different from each other, that is, are respectively 1000 mW/cm², and 500 mW/cm². Here, while the number of the foreign matters AFU was 0 in Example 5 having a smaller intensity of the light L of about 500 mW/cm², the number of the foreign matters AFU was 9 in Example 4 having a greater intensity of the light L of about 1000 mW/cm². From this result, it may be confirmed that as the intensity of the light L increases under the same condition, the number of the foreign matters AFU increases.

In addition, referring to Examples 2 and 3, the negative pressures supplied by the suction pump 131 were the same as about-30 kPa, and only the intensities of the light L were different from each other, that is, are respectively 2000 mW/cm² and 1000 mW/cm². Here, while the number of the foreign matters AFU in Example 3 having a smaller intensity of the light L of 1000 mW/cm² was 0, the number of the foreign matters AFU in Example 2 having a greater intensity of the light L of 2000 mW/cm² was 21. From this result, it may be confirmed that as the intensity of the light L increases under the same condition, the number of the foreign matters AFU increases.

Referring to Example 4, when the intensity of the light L was 1000 mW/cm², and the negative pressure was-15 kPa, the number of the foreign matters AFU was 9. Referring to Example 3, when the intensity of the light L was 1000 mW/cm² which is the same as in Example 4 and the negative pressure was-30 kPa, the number of the foreign matters AFU was 0. Referring to Examples 3 and 4, it may be confirmed that as the negative pressure increases, the number of the foreign matters AFU may decrease.

Referring to Example 2, when the intensity of the light L was 2000 mW/cm², and the negative pressure was-30 kPa, the number of the foreign matters AFU was 21. Referring to Example 1, when the intensity of the light L was 2000 mW/cm² which is the same as in Example 2 and the negative pressure was-60 kPa, the number of the foreign matters AFU was 0. Referring to Examples 1 and 2, it may be confirmed that as the negative pressure increases, the number of the foreign matters AFU may decrease.

Referring to Examples 2 and 3, it may be confirmed that although the negative pressures are the same as −30 kPa, the number of the foreign matters AFU increases from 0 (Example 3) to 21 (Example 2) when the intensity of the light L increases from 1000 mW/cm² (Example 3) to 2000 mW/cm² (Example 2). Here, it may be confirmed that as the negative pressure increases to about-60 kPa under the same condition as in Example 1, the number of the foreign matters AFU decreases to 0 again.

Referring to Examples 4 and 5, it may be confirmed that even in a case in which the negative pressure is the same as each other as about-15 kPa, the number of the foreign matters AFU increases from 0 (Example 5) to 9 (Example 4) when the intensity of the light L increases from 500 mW/cm² (Example 5) to 1000 mW/cm² (Example 4). Here, it may be confirmed that as the negative pressure increases to about-30 kPa under the same condition as in Example 3, the number of the foreign matters AFU decreases to 0 again.

Considering the results of Table 1 above, it may be confirmed that as the intensity of the light L increases, the number of the foreign matters AFU increases, and as the negative pressure increases, the number of the foreign matters AFU decreases. Accordingly, it may be appropriate that in order to effectively decrease the number of the foreign matters AFU, the absolute value of the negative pressure is controlled to increase in proportion to the intensity of the light L.

Table 2 below shows a required time for the total process according to use of the printing device 10 in FIGS. 1 to 4B. Table 2 shows changes of the required time for the total process according to the intensity of the light L emitted by the light-emitting element 120.

TABLE 2

| | Intensity | Required time(sec) | | | |
|---|---|---|---|---|---|
| | of light L | Applying | Curing | Total | Difference |
| Example | (mW/cm²) | process | process | process | (Times) |
| Comparative | 150 | 12 | 30 | 42 | 2.63 |
| Example 2 | | | | | |
| Example 7 | 1000 | 12 | 4 | 16 | |

Referring to Table 2, it may be confirmed that the required time for the process changes according to the intensity of the light L. Comparing Example 7 and Comparative Example 2 demonstrates that when the intensity of the light L changed, the required time for the curing process changed. In Example 7 and Comparative Example 2, the required times for the applying process were all constant as about 12 sec. Referring to Comparative Example 2, when the intensity of the light L was 150 mW/cm², the required time for the curing process was 30 sec. Referring to Example 7, when the intensity of the light L was 1000 mW/cm², the required time for the curing process was 4 sec. Referring to Comparative Example 2 and Example 7, it may be confirmed that when the intensity of the light L increases, the required time for the curing process is greatly reduced.

It may be confirmed that the required time for the total process in Comparative Example 2 was 42 sec, but the required time in Example 7 was decreased to 16 sec. It may be confirmed that the required time for the total process in Comparative Example 2 was about 2.63 times longer than that in Example 7. Considering the data in Table 2, it may be confirmed that increasing the intensity of the light L is effective in reducing the required time for the total process. A side effect in which the foreign matters AFU occur due to the increase in the intensity of the light L may be solved by increasing the negative pressure of the suction pump 131 as described above in Table 1.

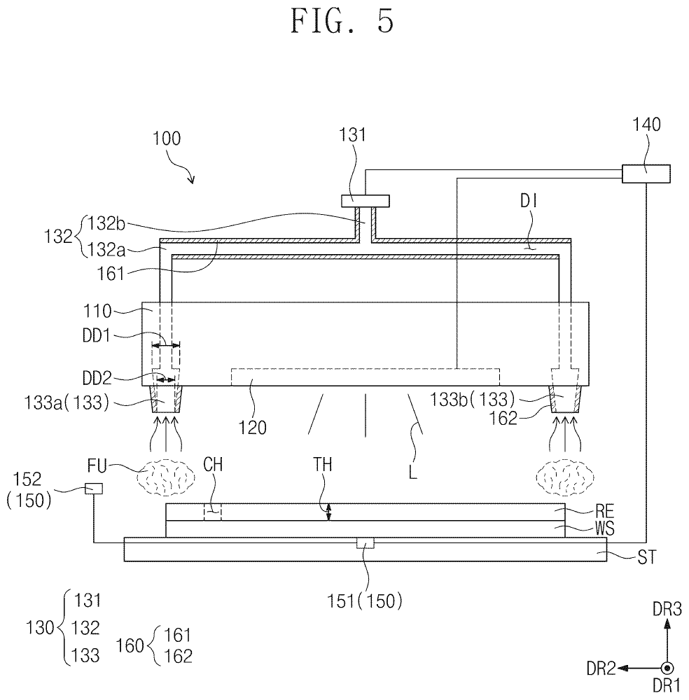

FIG. 5 is a side view of a light irradiation module 100 according to some embodiments of the present disclosure.

Referring to FIG. 5, the light irradiation module 100 may include a heater 160. Hereinafter, the same reference numerals or symbols are used for the same components as those described with reference to FIGS. 1 to 3, and some duplicate descriptions therefor may be omitted.

The heater 160 may be coupled to at least one of an exterior of the duct 132 or an exterior of the suction tube 133. The heater 160 may supply heat to the duct 132 and the suction tube 133 to prevent the collected gas FU from being liquefied. The heater 160 may have any configuration capable of supplying heat to the duct 132 and the suction tube 133. For example, the heater 160 may be a heating wire surrounding the duct 132 and the suction tube 133.

The heater 160 may include a first heater 161 and a second heater 162. The first heater 161 may be coupled to one region of an outer surface of the duct 132 to supply heat to the duct 132. The first heater 161 may supply heat to the duct 132 to prevent the gas FU moving through the internal space D1 from being deprived of heat to be reliquefied. The second heater 162 may surround the outer surface of the suction tube 133 to supply heat to the suction tube 133. The second heater 162 may prevent the gas FU collected in the suction tube 133 from being deprived of heat to be reliquefied. The second heater 162 may be a heating jacket surrounding the outer surface of the suction tube 133.

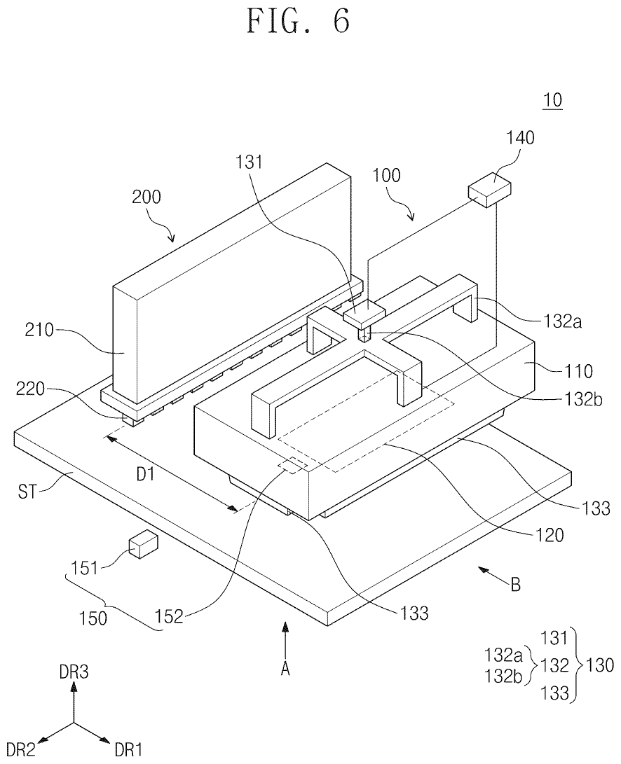

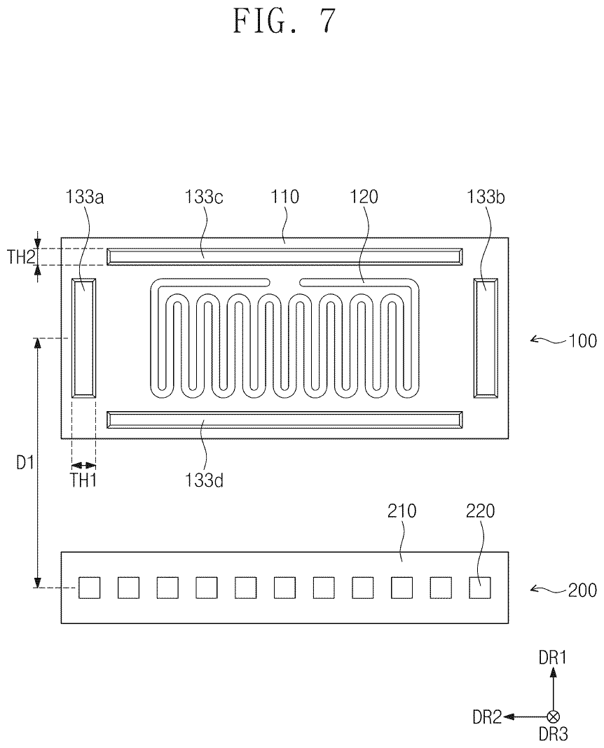

FIG. 6 is a perspective view of a printing device 10 according to some embodiments of the present disclosure. FIG. 7 is a bottom view of a light irradiation module and a print head according to some embodiments of the present disclosure. FIG. 7 is a bottom view as seen in direction A in FIG. 6. Hereinafter, the same reference numerals or symbols will be used for the same components as those described with reference to FIGS. 1 to 3, and some duplicate descriptions therefor may be omitted.

Referring to FIGS. 6 and 7, the suction tube 133 may include first suction tubes 133a and 133b and second suction tubes 133c and 133d. The first suction tubes 133a and 133b may be respectively located adjacent to both sides of the light-emitting element 120 in the second direction DR2. The second suction tubes 133c and 133d may be respectively located adjacent to both sides of the light-emitting element 120 in the first direction DR1. The first suction tubes 133a and 133b may include a (1-1)-th suction tube 133a located adjacent to one side of the light-emitting element 120 in the second direction DR2, and a (1-2)-th suction tube 133b located adjacent to the other side of the light-emitting element 120 in the second direction DR2.

The second suction tubes 133c and 133d may include a (2-1)-th suction tube 133c located adjacent to one side of the light-emitting element 120 in the first direction DR1, and a (2-2)-th suction tube 133d located adjacent to the other side of the light-emitting element 120 in the first direction DR1. The (2-1)-th suction tube 133c and the (2-2)-th suction tube 133d may face each other along the first direction DR1 with the light-emitting element 120 therebetween. The (2-1)-th suction tube 133c and the (2-2)-th suction tube 133d may be respectively connected to end portions of the suction duct 132a.

The suction duct 132a may be directly connected to the suction tube 133. The suction duct 132a may have a plurality of branched end portions so as to be respectively connected to a plurality of suction tubes 133a, 133b, 133c, and 133d. The suction duct 132a may be branched into four paths, and end portions of the branched suction duct 132a may be respectively connected to the (1-1)-th to (2-2)-th suction tubes 133a, 133b, 133c, and 133d.

A width TH1 of each of the (1-1)-th suction tube 133a and the (1-2)-th suction tube 133b along the second direction DR2 may be greater than a width TH2 of each of the (2-1)-th suction tube 133c and the (2-2)-th suction tube 133d along the first direction DR1.

As the width TH2 of each of the (2-1)-th suction tube 133c and the (2-2)-th suction tube 133d along the first direction DR1 is greater, a distance D1 by which the light irradiation module 100 and the print head 200 are spaced apart from each other may become greater. As the distance D1 by which the light irradiation module 100 and the print head 200 are spaced apart from each other is greater, the time taken from the process of applying the coating solution by the print head 200 to the process of curing the coating solution by the light irradiation module 100 may be longer.

On the contrary, although the width TH1 of each of the (1-1)-th suction tube 133a and the (1-2)-th suction tube 133b along the second direction DR2 increases, the time taken from the process of applying the coating solution by the print head 200 to the process of curing the coating solution by the light irradiation module 100 may not be influenced. Accordingly, it may be advantageous that the width TH1 of the first suction tubes 133a and 133b along the second direction DR2 is greater than the width TH2 of the second suction tubes 133c and 133d along the first direction DR1. Consequently, an increase in the required time for the total process may be minimized or reduced, and thus a planar area occupied by the suction tube 133 may be maximized or increased.

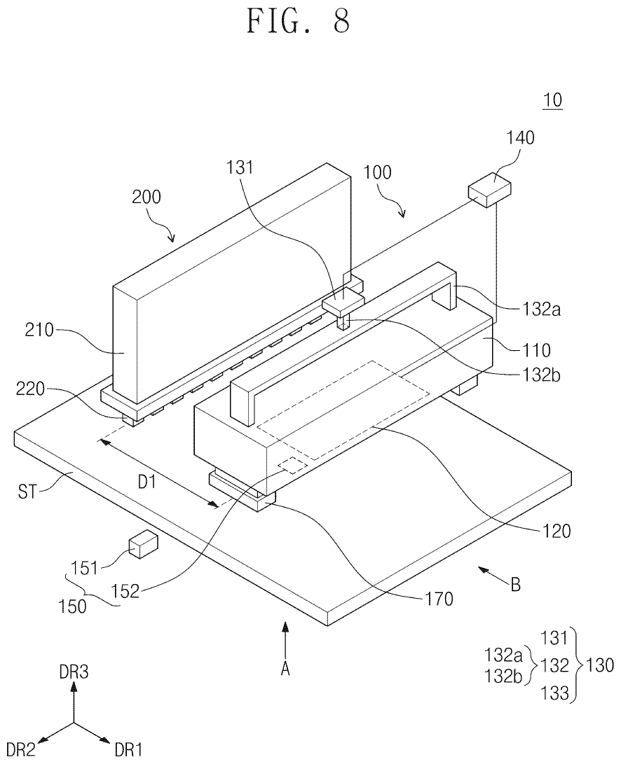

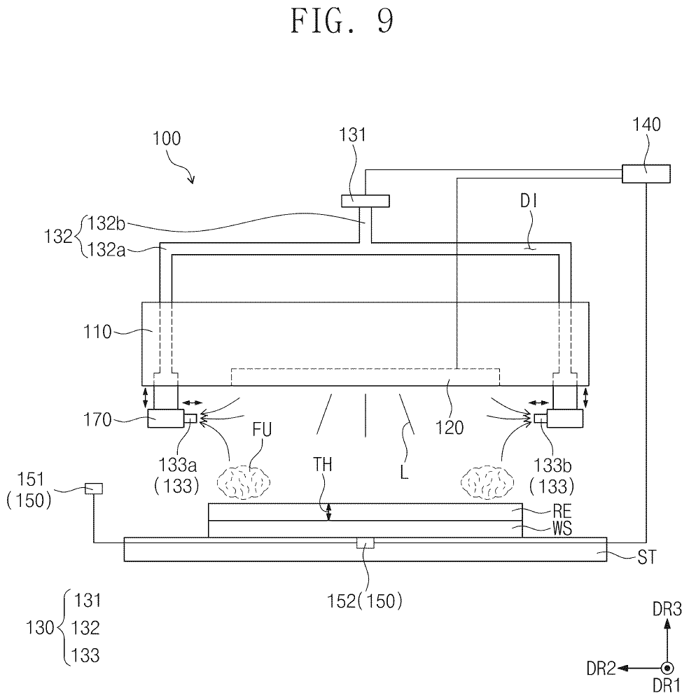

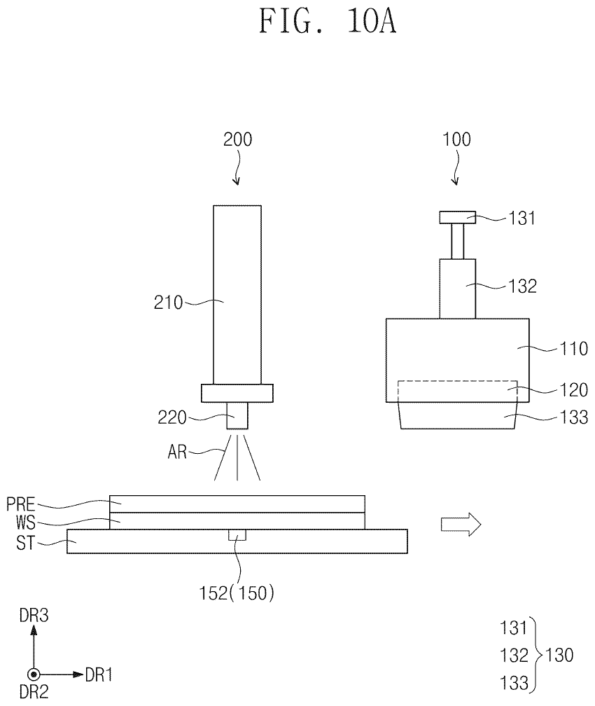

FIG. 8 is a perspective view of a printing device 10 according to some embodiments of the present disclosure. FIG. 9 is a side view of a light irradiation module 100 according to some embodiments of the present disclosure. FIG. 9 is a side view as seen in direction B in FIG. 8.

Referring to FIGS. 8 and 9, the printing device 10 may further include a moving unit 170 coupled between the duct 132 and the suction tube 133. The moving unit 170 may move each of the (1-1)-th suction tube 133a and the (1-2)-th suction tube 133b. The moving unit 170 may have any configuration capable of moving a position of the suction tube 133 according to a shape of the coating layer RE.

The moving unit 170 may move the position of the suction tube 133 according to the shape of the coating layer RE. For example, when a width of the coating layer RE in the second direction DR2 is relatively small, the moving unit 170 may move the (1-1)-th suction tube 133a to the right side and the (1-2)-th suction tube 133b to the left side. At this time, the (1-1)-th suction tube 133a and the (1-2)-th suction tube 133b may be more adjacent to the coating layer RE that generates the gas FU. The (1-1)-th suction tube 133a and the (1-2)-th suction tube 133b may be placed adjacent to the gas FU, thereby suctioning the gas FU more effectively.

For example, when a thickness TH of the coating layer RE is small, the moving unit 170 may move the (1-1)-th suction tube 133a and the (1-2)-th suction tube 133b in a downward direction, which is an opposite direction of the third direction DR3. At this time, the (1-1)-th suction tube 133a and the (1-2)-th suction tube 133b may be more adjacent to the coating layer RE that generates the gas FU. The (1-1)-th suction tube 133a and the (1-2)-th suction tube 133b may be placed adjacent to the gas FU, thereby suctioning the gas FU more effectively.

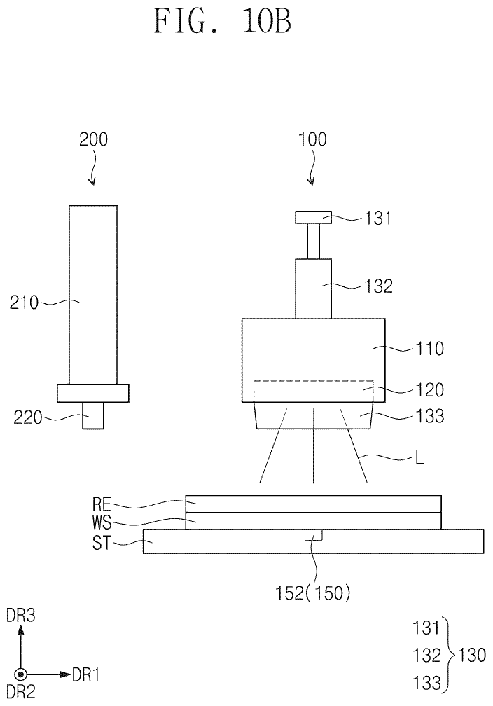

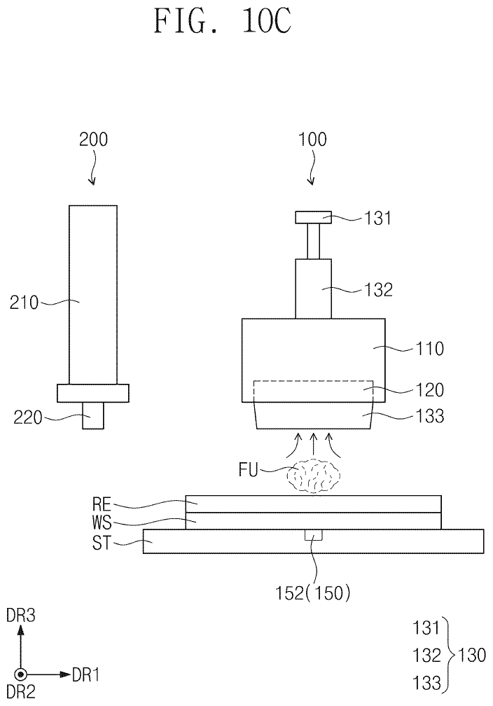

FIGS. 10A to 10C are front views illustrating operations of a printing device 10 according to some embodiments of the present disclosure.

Referring to FIG. 10A, a print head 200 may apply a coating solution AR onto a substrate WS (applying process). The applied coating solution AR may form a preliminary coating layer PRE. Here, the coating solution AR may be an optically clear resin, an optically clear adhesive, or a light-blocking material. The coating solution AR may be an acrylic resin. However, a type of the coating solution AR is not limited thereto, and any type of material forming the coating layer RE generated through the processes of applying and curing may be used.

A viscosity of the coating solution AR may be about 8 cP to about 20 cP. When the viscosity of the coating solution AR is less than about 8 cP, it may be difficult to control the coating solution AR in the process. When the viscosity of the coating solution AR is greater than about 20 cP, discharge of the coating solution AR through a nozzle 220 of the print head 200 may occur.

Referring to FIGS. 10A and 10B, a stage ST on which the substrate WS and the preliminary coating layer PRE are seated may move in the first direction DR1. The stage ST on which the substrate WS and the preliminary coating layer PRE are seated may overlap a light irradiation module 100. The light irradiation module 100 may emit light L onto the preliminary coating layer PRE on the substrate WS. The preliminary coating layer PRE may be cured by the light L emitted by the light irradiation module 100 to form the coating layer RE (curing process). As an intensity of the light L emitted by the light irradiation module 100 is greater, the required time for the curing process may become shorter. However, as the intensity of the light L emitted by the light irradiation module 100 is greater, the coating solution AR may be vaporized, and thus much more gas FU (see FIG. 10C) may be generated.

Referring to FIGS. 10B and 10C, the gas FU may be generated by the light L emitted by the light irradiation module 100. The gas FU may be suctioned and exhausted by an exhaust unit 130 (exhausting process). A negative pressure supplied by the suction pump 131 may be transferred to the suction tube 133 through the duct 132. The gas FU may be collected by the negative pressure transferred to the suction tube 133. The curing process in FIG. 10B and the exhausting process in FIG. 10C may be simultaneously performed.

FIG. 11 is an exploded perspective view schematically illustrating a display device DD.

Referring to FIG. 11, the display device DD may be an organic light-emitting display device as a device for displaying an image, but embodiments of the present disclosure are not limited thereto. For example, the display device may be a liquid crystal display device.

The display device DD may include a display panel DP, an optical unit PL, an adhesive layer ADS, a light-blocking layer BL, and a window WP. However, a configuration of the display device DD is not limited thereto, and other general-purpose components may be further included.

The display panel DP may have a display region DA and a non-display region NDA surrounding the display region DA. The display panel DP may display images through the display region DA. The display panel DP may include a light-emitting layer DP-EL and an encapsulation layer TFE. The light-emitting layer DP-EL may include a substrate, and a pixel layer located on the substrate and including a plurality of pixels. The pixels layer may include multiple pixels, and the multiple pixels may each include an anode, a cathode, and an organic light-emitting element located between the anode and the cathode.

The encapsulation layer TFE may be located on the light-emitting layer DP-EL. The encapsulation layer TFE may seal the pixel layer to protect the pixel layer from external moisture and foreign matters. The encapsulation layer TFE may have a structure in which an organic layer and an inorganic layer are alternatingly and repeatedly stacked. The display panel DP may have a structure described above, but is not limited to the structure of the display panel DP described above.

The optical unit PL may polarize or block light emitted by the display panel DP. The optical unit PL may be attached onto the encapsulation layer TFE. The optical unit PL may be an anti-reflective layer blocking light incident from the outside.

The window WP may cover the display panel DP, and protect the display panel DP from an external impact. The window WP may be a glass substrate or a plastic substrate having transmittance.

The light-blocking layer BL may be located on a rear surface of the window WP, and overlap the non-display region NDA. The light-blocking layer BL may include a light-absorbing material such as carbon black. The light-blocking layer BL may be further located on not only the rear surface of the window WP but also a side surface of the window WP.

The adhesive layer ADS may be interposed between the display panel DP and the window WP to attach the window WP to the display panel DP. In FIG. 11, the adhesive layer ADS is expressed as a single layer, but may be provided in plurality as needed. For example, the adhesive layer ADS may be located between the display panel DP and the optical unit PL to attach the optical unit PL onto the display panel DP. The adhesive layer ADS may be formed by applying and then curing a liquid adhesive.

The adhesive layer ADS and the light-blocking layer BL of the display device DD may be formed using the printing device 10 (see FIG. 1) according to the present disclosure. That is, a liquid adhesive or a light-blocking material may be applied and cured by the printing device 10 (see FIG. 1) to form the adhesive layer ADS or the light-blocking layer BL.

However, components capable of being formed by the printing device 10 (see FIG. 1) according to the present disclosure are not limited to the adhesive layer ADS and the light-blocking layer BL. For example, the display device DD may further include a protective layer located on the window WP. The printing device 10 (see FIG. 1) according to some embodiments of the present disclosure may apply and cure a liquid coating material having excellent impact resistance to form the protective layer.

A light irradiation module according to some embodiments of the present disclosure, and a printing device including the same may include a suction pump and a suction tube adjacent to a light-emitting element, thereby removing a vaporized coating solution generated in a process of curing the coating layer.

In addition, because a negative pressure of the suction pump of the light irradiation module according to some embodiments of the present disclosure and the printing device including the same is proportional to an intensity of light, an exhaust pressure may be actively controlled according to the intensity of the light.

In the above, description has been made with reference to aspects of some embodiments of the present disclosure, but those skilled in the art or those of ordinary skill in the relevant technical field may understand that various modifications and changes may be made to embodiments according to the present disclosure within the spirit and scope not departing from the spirit and the technology scope of embodiments according to the present disclosure described in the appended claims. Therefore, the technical scope of embodiments according to the present disclosure is not limited to the contents described in the detailed description of the specification, but should be determined by the appended claims, and their equivalents.

What is claimed is:

1. A light irradiation module comprising:
a stage on which a substrate and a coating layer on the substrate are seated, and which moves in a first direction;
a body on the stage;
a light-emitting element in a center of the body, and emitting light onto the stage;
a first suction tube adjacent to the light-emitting element in a second direction crossing the first direction;
a duct connected to the first suction tube; and
a suction pump connected to the duct, and supplying a negative pressure having an absolute value proportional to an intensity of the light to the first suction tube.

2. The light irradiation module of claim 1, wherein the first suction tube is provided in plurality, and
the first suction tubes comprise:
a (1-1)-th suction tube adjacent to a first side of the light-emitting element in the second direction; and
a (1-2)-th suction tube adjacent to a second side of the light-emitting element in the second direction.

3. The light irradiation module of claim 2, wherein the (1-1)-th suction tube and the (1-2)-th suction tube face each other with the light-emitting element therebetween.

4. The light irradiation module of claim 1, further comprising a control unit connected to the light-emitting element and the suction pump, and transmitting an output signal related to the negative pressure and proportional to an input signal to the suction pump, based on the input signal received from the light-emitting element.

5. The light irradiation module of claim 4, wherein the control unit receives a thickness of the coating layer as an initial input value, and to change the output signal so that as the initial input value increases, an absolute value of the negative pressure corresponding to the output signal increases.

6. The light irradiation module of claim 4, wherein the control unit receives volatility of the coating layer as an initial input value, and to change the output signal so that as the initial input value increases, an absolute value of the negative pressure corresponding to the output signal increases.

7. The light irradiation module of claim 1, wherein as the first suction tube gets farther away from the duct, a diameter of the first suction tube becomes smaller.

8. The light irradiation module of claim 4, further comprising a temperature sensor connected to the control unit and measuring a temperature of the substrate.

9. The light irradiation module of claim 8, wherein the control unit controls the output signal based on the temperature measured by the temperature sensor.

10. The light irradiation module of claim 8, wherein the temperature sensor comprises:
a first temperature sensor coupled to an upper surface of the stage, and measuring the temperature of the substrate while being in contact with the substrate; and
a second temperature sensor spaced apart from the stage, and measuring temperatures of the substrate and the coating layer while not being in contact with the substrate.

11. The light irradiation module of claim 2, further comprising a second suction tube adjacent to the light-emitting element in the first direction,
wherein the second suction tube is provided in plurality, and
the second suction tubes include a (2-1)-th suction tube and a (2-2)-th suction tube face each other along the first direction with the light-emitting element therebetween.

12. The light irradiation module of claim 11, wherein a width of the (1-1)-th suction tube along the second direction is greater than a width of the (2-1)-th suction tube along the first direction.

13. The light irradiation module of claim 1, further comprising a heater coupled to at least one of an exterior of the duct or an exterior of the first suction tube.

14. The light irradiation module of claim 13, wherein the heater is provided in plurality, and
the heaters comprise:
a first heater coupled to one region of an outer surface of the duct, and providing heat to the duct; and
a second heater surrounding an outer surface of the first suction tube, and providing heat to the suction tube.

15. The light irradiation module of claim 1, further comprising a moving unit coupled between the duct and the first suction tube, and moving the first suction tube along a shape of the coating layer.

16. The light irradiation module of claim 1, wherein the light-emitting element and the suction pump start operating at a same time.

17. A printing device comprising:
a stage on which a substrate is seated, and which moves in a first direction;
a light irradiation module on the stage, and irradiating the stage with light; and
a print head on the stage and behind the light irradiation module in the first direction, and applying a coating solution onto the substrate to form a coating layer,
wherein the light irradiation module includes:
a body on the stage;
a light-emitting element in a center of the body, and emitting light onto the stage;
a suction tube adjacent to the light-emitting element in a second direction crossing the first direction;
a duct connected to the suction tube; and
a suction pump connected to the duct, and supplying a negative pressure having an absolute value proportional to an intensity of the light to the suction tube.

18. The printing device of claim 17, wherein a distance by which the print head is spaced apart from the light irradiation module along the first direction is about 200 millimeters (mm) or less.

19. The printing device of claim 17, wherein the suction tube is provided in plurality, and the suction tubes comprise:
a first suction tube adjacent to a first side of the light-emitting element in the second direction; and
a second suction tube adjacent to a second side of the light-emitting element in the second direction.

20. The printing device of claim 17, wherein as a thickness of the coating layer increases, an absolute value of the negative pressure provided by the suction pump increases.
